(19) United States
(12) Patent Application Publication
(10) Pub. No.: US 2014/0226078 A1
(43) Pub. Date: Aug. 14, 2014

(54) REMOTE CONTROL FOR ELECTRONIC DISPLAY APPARATUS AND ELECTRONIC DISPLAY APPARATUS

(71) Applicant: Jiliang Yu, Qingdao City (CN)

(72) Inventor: Jiliang Yu, Qingdao City (CN)

(73) Assignee: Hisense Electric Co., Ltd., Qingdao City, Shandong Province (CN)

(21) Appl. No.: 14/346,738

(22) PCT Filed: Sep. 26, 2011
(86) PCT No.: PCT/CN2011/080165

§ 371 Date: Mar. 23, 2014

(51) Int. Cl. H04N 5/44; H04N 21/422

(52) U.S. Cl. CPC H04N 5/4403; H04N 21/42221; H04N 21/42212; H04N 2005/4416; H04N 2005/4426
USPC 348/734

(57) ABSTRACT

This disclosure provides a remote control for an electronic display apparatus, includes an operation panel disposed on a surface of the remote control, and a circuit board located inside the remote control. The circuit board includes a control module and a signal emitting module. The operation panel includes a key group. The key group includes an enter key, an inner ring direction key, and an outer ring direction key. The control module is connected to the key group for recognizing different press operations. If the press operation is on the inner ring direction key, a signal for moving a cursor displayed on a display device of the electronic display apparatus one item is emitted through the signal emitting module. If the press operation is on the outer ring direction key, a signal for moving a cursor displayed on the display device of the electronic display apparatus at least two items is emitted through the signal emitting module. The remote control is capable of realizing cursor's multi-item movement by pressing one key, which facilitates user's operation for the user and makes the operation to be accurate, and further substantially could not increase the manufacturing cost of the remote control.

### CROSS-REFERENCE

This application is a U.S. National Stage Filing under 35 U.S.C. §371 from International patent application Ser. No. PCT/CN2011/080165, filed Sep. 26, 2011, and published on Apr. 4, 2013 as WO 2013/044435A1 in Chinese, which is incorporated herein reference in its entirety.

### FIELD OF THE INVENTION

This disclosure relates to a remote control, and more particularly to a remote control for an electronic display apparatus and the electronic display apparatus.

### BACKGROUND

Presently, as an important interactive apparatus, remote controls are widely used in TV, STB, Network VOD Equipment, DVD, or other electronic display apparatuses. In the conventional remote control of the electronic display apparatus, the main operation area, i.e. layout of the keys on the operation panel, is basically finalized. The operation area usually includes a cruciform key, i.e., an OK or Enter key disposed in the middle (hereinafter called “enter key”) and four direction keys (i.e., “Up”, “Down” “Left” and “Right” keys) disposed around the enter key. The cruciform key makes it convenient for users to perform selection function by moving a focus or cursor (hereinafter called “cursor”) displayed on a display device of the electronic display apparatus. That is, moving cursor to a desirable position by pressing “Up”, “Down” “Left” and “Right” keys in one-press-one-item manner and then pressing enter key to confirm.

However, as more functions the electronic display apparatus has, and more items appear, if the cursor needs to be moved to a desirable position, the user usually needs to move the cursor many times from up to down and from left to right. That is, it needs more times of press on the direction keys. Taken image 9 shown by the display device of the electronic display apparatus of FIG. 1 as an example, if the user wants to move the cursor from item 90 located at the top left corner to item 92 located at the bottom right corner, the Right key of the cruciform key needs be pressed seven times, and then the Down key needs be pressed four times. Even though the electronic display apparatus has a function of moving the cursor on the display device from the leftmost to the rightmost side by pressing the Left key, that is, the electronic display apparatus has a function of jumping to the rightmost side. The user still needs to press the Left key one time and then press the Down key four times to accomplish the cursor movement. This brings inconvenience for users to manipulate the electronic display apparatus.

As for the forgoing problems, the art has already provided some solutions. One of the solutions is giving the “Up”, “Down” “Left” and “Right” keys of the cruciform key of long press and short press functions. That is, if the user presses the direction key in a short time, the cursor moves one item in a corresponding direction; if the user presses the direction key in a long time, the cursor moves two or three items in the corresponding direction. However, such solution has obvious flaws. Firstly, if the user frequently performs long press operation on the direction keys, the keys are easily damaged and accordingly influence the service life of the remote control. Secondly, the setup of long press operation and short press operation complicates the usage of the remote control, it is uneasy for users to familiar the difference between long press operation and short press operation, which easily results misoperation and lowers operation accuracy.

The other one of the solutions is changing the operation panel of the remote control to touch panel, therefore, the user is capable of manipulating the remote control by selecting items on the touch panel, which corresponds to items on the display device of the electronic display apparatus. However, such solution increases the manufacturing cost of the remote control, and the remote control in touch panel style does not consistent with manipulation habits when ordinary users manipulate a remote control. Furthermore, the operation is complicated and accordingly makes users feel unaccustomed and brings operation difficulties.

Otherwise, in the conventional remote control of the electronic display apparatus, there are still some keys needs more times of press to reach a desirable location or realize a desirable function, such as channel switch buttons or volume adjusting buttons in remote controls of televisions, or fast forward buttons or fast backward buttons in remote controls of DVDs. Such buttons still have the problem of operation inconvenient.

### SUMMARY

For solving the forgoing problems, the purpose of this disclosure is to provide a remote control for an electronic display apparatus, the remote control is capable of realizing cursor's multi-item movement by pressing one key, which facilitates user's operation and makes the operation to be more accurate, and substantially could not increase the manufacturing cost of the remote control.

Another purpose of this disclosure is to provide a remote control for an electronic display apparatus, the remote control includes a key capable of realizing functions of pressing corresponding keys many times by one-time press, which facilitates user's operation and makes the operation to be accurate, and substantially could not increase the manufacturing cost of the remote control.

A further purpose of this disclosure is to provide an electronic display apparatus, a remote control of the electronic display apparatus includes a key capable of realizing functions of pressing corresponding keys many times by one-time press, which facilitates user's operation of a display device of the electronic display apparatus and makes the operation to be accurate, and substantially could not increase the manufacturing cost of the remote control.

This disclosure provides a remote control for an electronic display apparatus. The remote control includes an operation panel disposed on a surface of the remote control, and a circuit board located inside the remote control. The circuit board includes a control module and is connected with the control module, and is capable of emitting signals generated by the remote control to a signal emitting module of a display device of the electronic display apparatus. The operation panel includes a key group. The key group includes an enter key disposed at a center, an inner ring direction key disposed around the enter key, and an outer ring direction key disposed around the inner ring direction key. The control module is connected to the key group for recognizing different press operations. If the press operation is on the inner ring direction key, a signal for moving a cursor displayed on the display device of the electronic display apparatus one item is emitted through the signal emitting module. If the press operation is on the outer ring direction key, a signal for moving a cursor displayed on the display device of the electronic display apparatus at least two items is emitted through the signal emitting module.

In an embodiment of this disclosure, the inner ring direction key and the outer ring direction key each includes four direction keys respectively directed to up, down, right and left directions.

In an embodiment of this disclosure, locations of the four direction keys of the inner ring direction key respectively correspond to locations of the four direction keys of the outer ring direction key.

In an embodiment of this disclosure, the four direction keys of the inner ring direction key and the four direction keys of the outer ring direction key respectively includes a common annular press portion, contacts corresponding to up, down, right and left directions are disposed below the common annular press portion.

In an embodiment of this disclosure, the four direction keys of the inner ring direction key and the four direction keys of the outer ring direction key are separate keys, and contacts are respectively disposed below the direction keys.

In an embodiment of this disclosure, the preset functions of the keys of the key group are stored in the control module.

In an embodiment of this disclosure, as for the inner ring direction key, the preset function in the control module is to move a cursor displayed on the display device of the electronic display apparatus one item in a corresponding direction from the present location, and as for the outer ring direction key of the key group, the preset function in the control module is to move the cursor displayed on the display device of the electronic display apparatus more than two items in a corresponding direction from the present location.

In an embodiment of this disclosure, the signal emitting module is a wireless emitting module including an infrared emitting module, or a radio-frequency emitting module, or etc.

This disclosure also provides a remote control for an electronic display apparatus. The remote control includes an operation panel disposed on a surface of the remote control, and a circuit board located inside the remote control. The circuit board includes a control module and is connected with the control module, and is capable of emitting signals generated by the remote control to a signal emitting module of a display device of the electronic display apparatus. The operation panel includes a key group. The key group includes a first key and a second key. The control module is connected to the key group for recognizing different press operations. If the press operation is on the first key, a signal for making the display device of the electronic display apparatus to perform a preset function one time is emitted through the signal emitting module. If the press operation is on the second key, a signal for making the display device of the electronic display apparatus to perform the preset function more than two times is emitted through the signal emitting module.

In an embodiment of this disclosure, the preset functions of the keys of the key group are stored in the control module.

In an embodiment of this disclosure, the preset functions may be volume adjusting, channel switching, play progress changing, cursor moving, page turning, or etc.

In an embodiment of this disclosure, the signal emitting module is a wireless emitting module including an infrared emitting module, or a radio-frequency emitting module, or etc.

This disclosure further provides an electronic display apparatus includes a display device and a remote control. The remote control includes an operation panel disposed on a surface of the remote control, and a circuit board located inside the remote control. The circuit board includes a control module and is connected with the control module, and is capable of emitting signals generated by the remote control to a signal emitting module of the electronic display apparatus. The operation panel includes a key group. The key group includes a first key and a second key. The control module is connected to the key group for recognizing different press operations. If the press operation is on the first key, a signal for performing a preset function one time is emitted to the display device through the signal emitting module, and the display device performs the preset function one time. If the press operation is on the second key, a signal for performing the preset function more than two times is emitted to the display device through the signal emitting module, and the display device performs the preset function more than two times.

In an embodiment of this disclosure, the display device includes a signal receiving module. In an embodiment of this disclosure, the preset functions of the keys of the key group of the remote control are stored in the control module, and the preset function may be volume adjusting, channel switching, play progress changing, cursor moving, page turning, or etc.

The advantage of this disclosure is, the electronic display apparatus using the remote control is capable of realizing cursor's multi-item movement by pressing one key, which facilitates user's operation and makes the operation to be accurate, and substantially could not increase the manufacturing cost of the remote control.

The advantage of this disclosure also includes the remote control having a key capable of realizing functions of pressing corresponding keys many times by one-time press, which facilitates user's operation and makes the operation to be accurate, and substantially could not increase the manufacturing cost of the remote control.

The advantage of this disclosure further includes the remote control of the electronic display apparatus having a key capable of realizing functions of pressing corresponding keys many times by one-time press, which facilitates user's operation of a display device of the electronic display apparatus and makes the operation to be accurate, and substantially could not increase the manufacturing cost of the remote control.

The forgoing description is only for summarizing technological means of this disclosure. In order to know the technical solutions more clearly so that this disclosure could be carried out according to the descriptions in the specification, and to know the forgoing or other purposes, features and advantages of this disclosure more obviously and easily, embodiments are given below, accompanying drawings for detailed description.

### BRIEF DESCRIPTION OF THE DRAWINGS

FIG. 1 is an image shown in a display device of an electronic display apparatus using a preferred embodiment of the remote control for electronic display apparatus of this disclosure.

FIG. 2 is a schematic view of the remote control for electronic display apparatus according to a preferred embodiment of this disclosure.

FIG. 3 is a schematic, exploded three-dimensional view of a key group of the remote control for electronic display apparatus according to a preferred embodiment of this disclosure.

FIG. 4 is a function block of the remote control for electronic display apparatus according to a preferred embodiment of this disclosure.

FIG. 5 is a schematic view of the remote control for electronic display apparatus according to another embodiment of this disclosure.

### DETAILED DESCRIPTION OF PREFERRED EMBODIMENTS

For further clarifying the technological means for achieving the purposes and functions of this disclosure, drawings and embodiments are presented herein for purpose of detailed description of embodiments, structures, features and functions of the remote control for the electronic display apparatus and the electronic display apparatus according to this disclosure.

The forgoing or other technical solutions, features and functions of this disclosure will be described more clearly in the detailed description of the embodiments accompanying reference drawings. Through the description of embodiments, the technological means to achieve the purposes and functions of this disclosure could be known further and more specifically. However, the drawings are for purpose of illustration and description only. It is not intended to limit this disclosure.

In this embodiment, the electronic display apparatus is a television, which includes a display functioning as a display device, and a remote control.

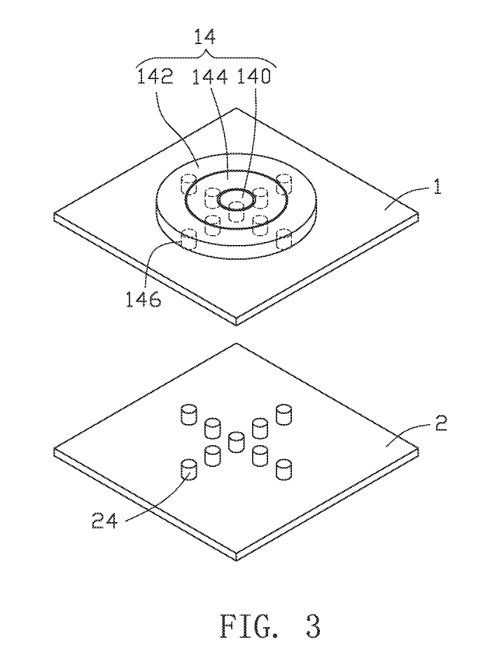

Referring to FIGS. 2 and 3, the remote control for the electronic display apparatus is substantially in rectangular shape, and includes an operation panel 1 disposed at a surface of the remote control, and a circuit board 2 disposed inside the remote control.

The operation panel 1 includes a plurality of keys 12 and a key group 14. Each of the keys 12 has a contact (not shown) disposed therebelow. The key group 14 includes an enter key 140 disposed at a center, an inner ring direction key 142 disposed around the enter key 140, and an outer ring direction key 144 disposed around the inner ring direction key 142. In this embodiment, the inner ring direction key 142 and the outer ring direction key 144 each includes four direction keys respectively directed to Up, Down, Right and Left directions. Furthermore, locations of the direction keys of the inner ring direction key 142 respectively correspond to locations of the direction keys of the outer ring direction key 144. The four direction keys of the inner ring direction key 142 and the four direction keys of the outer direction key 144 could be four separate keys or could also be formed into a single piece, that is, the four direction keys have a common annular press portion as shown in FIG. 3. Contacts 146 corresponding to Up, Down, Right and Left directions are disposed below the annular press portion.

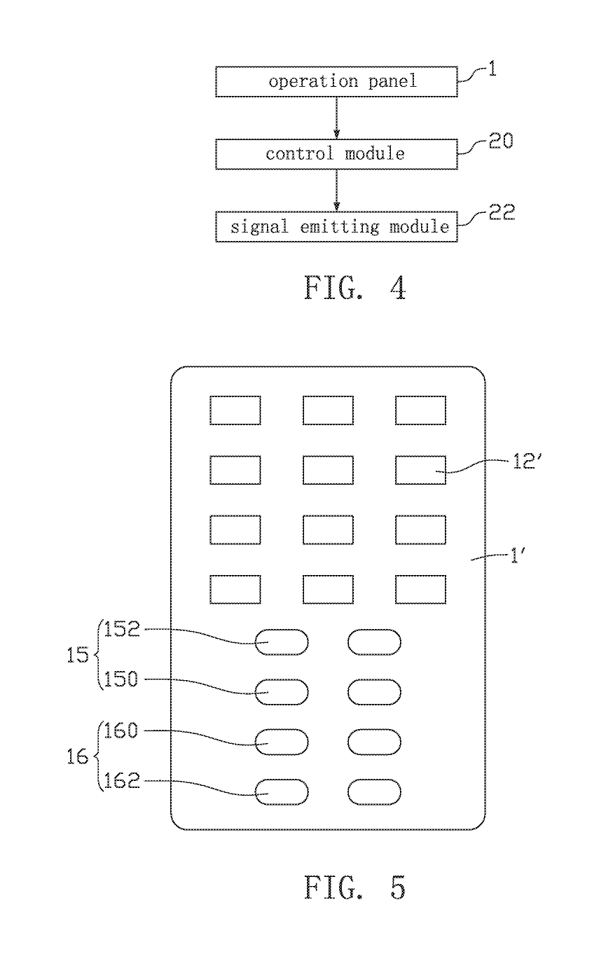

Referring to FIGS. 3 and 4, the circuit board 2 of the remote control has a plurality of circuits, a plurality of contact switches 24, a control module 20 and a signal emitting module 22. The contact switches 24 and the contacts of the keys 12 and the key group 14 have the same number and corresponding locations. When the key 12 or the key of the key group 14 is pressed, the corresponding contact 146 activates the corresponding contact switch 24. The control module 20 is used for recognizing different press operations, and storing preset functions of the keys 12 and the keys of the key group 14 therein. The control module 20 is connected to the signal emitting module 22. The signal emitting module 22 is used for emitting signal generated by the control module 20 to the display device manipulated by the remote control. When any one of the keys 12 and the keys of the key group 14 on the operation panel 1 is pressed, the corresponding contact 146 activates the corresponding contact switch 24, and the control module 20 sends an electronic signal corresponding to the preset function of the activated key to the signal emitting module 22, the signal emitting module 22 further sends the signal to the display device manipulated the remote control. The signal emitting module 22 is usually a wireless emitting module, such as an infrared emitting module or a radio-frequency emitting module, or etc.

In this embodiment, as for the inner ring direction key 142 of the key group 14, the preset function in the control module 20 is to move the cursor displayed on the display device of the television one item in a corresponding direction from the present location. Therefore, when a key (for example, the Up key) of the inner ring direction key 142 is pressed, a signal for moving cursor displayed on the display device of the television upwardly to a next item from the present location is emitted from the control module 20 to the display device through the signal emitting module 22. As for the outer ring direction key 144 of the key group 14, the preset function in the control module 20 is to move the cursor displayed on the display device of the television two items in a corresponding direction from the present location. Therefore, when a key (for example, the Down key) of the outer ring direction key 144 is pressed, a signal for moving cursor displayed on the display device of the television downwardly to next two items from the present location is emitted from the control module 20 to the television through the signal emitting module 22.

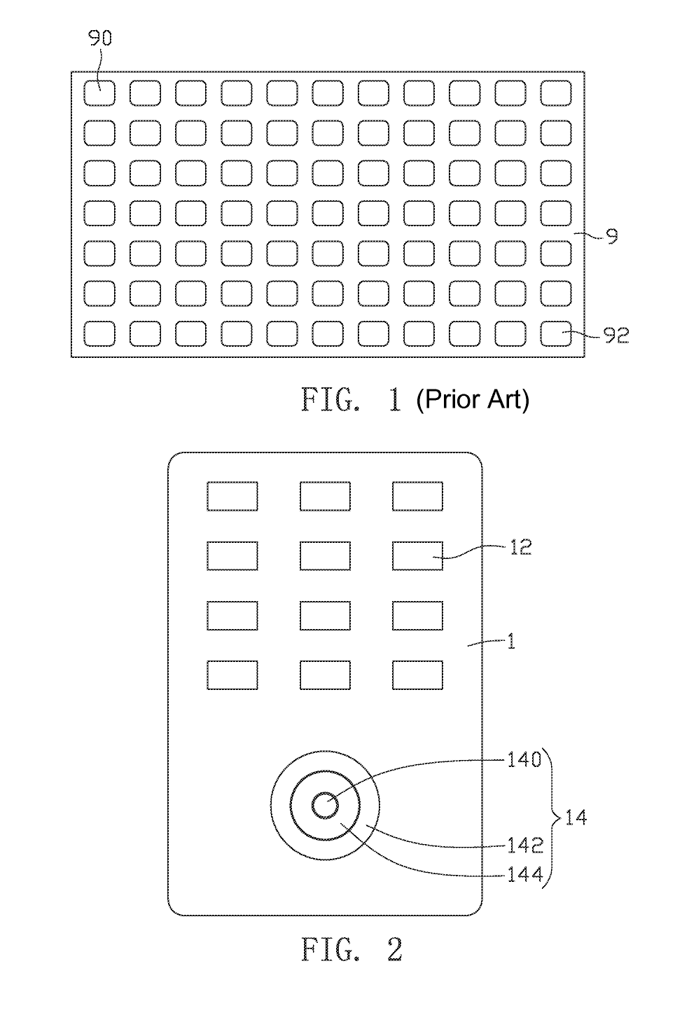

In this way, if the cursor displayed on the display device of the television needs to be moved to a desirable location, taken image 9 shown in FIG. 1 as an example, if the user wants to move the cursor from item 90 located at the top left corner of the image to item 92 located at the bottom right corner of the image, the Right key of the outer ring direction key 144 needs be pressed three times, and then the Right key of the inner ring direction key 142 needs be pressed one time, and finally the Down key of the outer ring direction key 144 needs be pressed twice. If the television has a function of moving the cursor on the display device from the leftmost side to the rightmost side by pressing the Left key, that is, the electronic display apparatus has a function of jumping to the rightmost side. The user only needs to press the Left key of the inner ring direction key 142 one time, and then press the Down key of the outer ring direction key 144 twice. This decreases the number of press operation.

As for the outer ring direction key 144 of the key group 14, the preset function in the control module 20 might be to move cursor displayed on the display device of the television three items or four items in a corresponding direction from the present location. Therefore, when a key (for example, the Down key) of the outer ring direction key 144 is pressed, a signal for moving cursor displayed on the display device of the television downwardly to next three items or even four items from the present location is emitted from the control module 20 to the television through the signal emitting module 22. Under the status that the display device of the television displays many items, such design could make the cursor movement to be convenient, accurate and rapid.

It should be known that the structure of the key group 14 of the remote control for the electronic display apparatus is not limited to the structure displayed in FIG. 3. It might be thin film button or other buttons known in the art.

Referring to FIG. 5, in the remote control for the electronic display apparatus of a second embodiment of this disclosure, the operation panel 1′ includes a plurality of keys 12′ and two key groups 15, 16. The key group 15 includes a first key 150 and a second key 152. The key group 16 includes a first key 160 and a second key 162. The first keys 150 and 160 are volume control keys of the remote control of the television, and the first key 150 is for increasing the volume and the first key 160 is for decreasing the volume. That is, as for the first key 150, the preset function in the control module 20 is for increasing the volume one grade. Therefore, when the first key 150 is pressed, a signal for increasing the volume of the display device of the television one grade is emitted from the control module 20 to the display device through the signal emitting module 22. As for the first key 160, the preset function in the control module 20 is for decreasing the volume one grade. Therefore, when the first key 160 is pressed, a signal for decreasing the volume of the display device of the television one grade is emitted from the control module 20 to the television through the signal emitting module 22. For similar principles, as for the second key 152, the preset function in the control module 20 is for increasing the volume two grades. As for the second key 162, the preset function in the control module 20 is for decreasing the volume two grades. In such a way, the user pressing the second key 152 one time equals to pressing the first key 150 twice, therefore could increase the volume; and the user pressing the second key 162 one time equals to pressing the first key 160 twice, therefore could decrease the volume.

Similarly referring to FIG. 5, it could be known that, in a third embodiment of the remote control for the electronic display apparatus, the first key 150 of the key group 15 and the first key 160 of the key group 16 might be channel switch buttons. That is, if the user presses the first key 150 or 160 one time, the display device of the television is switched to a former or a later channel; if the user presses the second key 152 or 162 one time, the display device of the television is switched to a former two or three or a later two or three channel. That is, the user pressing the second key 152 one time equals to pressing the first key 150 twice or three times, and the user pressing the second key 162 one time equals to pressing the first key 160 twice or three times, therefore could rapidly switch to a desirable channel.

Similarly referring to FIG. 5, it could be known that, in a fourth embodiment of the remote control for the electronic display apparatus, the electronic display apparatus is a DVD and the remote control is a remote control for manipulating the DVD. The first key 150 of the key group 15 and the first key 160 of the key group 16 are fast forward key and fast backward key. That is, if the user presses the first key 150 one time, the DVD will forward in a determined speed; if the user presses the first key 160 one time, the DVD will backward in a determined speed. For the similar principle, if the user presses the second key 152 one time, the DVD will forward in a speed as twice or three times of the determined speed, that is, the user pressing the second key 152 one time equals to pressing the first key 150 twice or three times. If the user presses the second key 162 one time, the DVD will backward in a speed as twice or three times of the determined speed, that is, the user pressing the second key 162 one time equals to pressing the first key 160 twice or three times. Alternatively, the first key 150 and the second key 152 of the key group 15 may be fast backward keys, and the user pressing the second key 152 one time still equals to pressing the first key 150 twice or three times. Therefore, the fast forward or fast backward speed could reach to a desirable fast forward or fast backward speed rapidly.

In should be known that, in other embodiments of the remote control for the electronic display apparatus, besides the functions in the forgoing embodiments, the first key 150 of the key group 15 and the first key 160 of the key group 16 may be set to perform other preset functions, such as page turning function, or etc. The second key 152 of the key group 15 and the second key 162 of the key group 16 may be set to perform functions equal to perform more than two times the functions of the first keys, such as page turning function, or etc.

As mentioned above, the remote control for the electronic display apparatus includes a key capable of realizing functions of pressing corresponding keys many times by one-time press, which facilitates user's operation and makes the operation to be accurate, and substantially could not increase the manufacturing cost of the remote control.

The forgoing descriptions are embodiments of this disclosure only, and it is not intend to limit this disclosure in any form. Although this disclosure has already been disclosed by the forgoing embodiments, the purpose is not intended to limit this disclosure. For those of ordinarily skilled in the art, some equivalent embodiments with simple changes or equivalent modifications could be made on basis of the disclosed technological means within the spirit of this disclosure. The technical solutions made within the spirit of this disclosure, and the simple changes and equivalent modifications made on basis of the disclosed techniques according to the spirit of this disclosure are still within the scope of this disclosure.

### INDUSTRIAL APPLICABILITY

The remote control for the electronic display apparatus includes a key capable of realizing functions of pressing corresponding keys many times by one-time press, which facilitates user's operation and makes the operation to be accurate, and substantially could not increase the manufacturing cost of the remote control.

What is claimed is:

1. A remote control for an electronic display apparatus comprising:
an operation panel disposed on a surface of the remote control, and a circuit board located inside the remote control, the circuit board comprising a control module and being connected with the control module, and being capable of emitting signals generated by the remote control to a signal emitting module of a display device of the electronic display apparatus, wherein the operation panel comprises a key group, the key group comprises an enter key disposed at a center, an inner ring direction key disposed around the enter key, and an outer ring direction key disposed around the inner ring direction key, the control module is connected to the key group for recognizing different press operations, if the press operation is on the inner ring direction key, a signal for moving a cursor displayed on a display device of the electronic display apparatus one item is emitted through the signal emitting module; if the press operation is on the outer ring direction key, a signal for moving a cursor displayed on a display device of the electronic display apparatus at least two items is emitted through the signal emitting module.

2. The remote control for the electronic display apparatus according to claim 1, wherein the inner ring direction key and the outer ring direction key each comprises four direction keys respectively directed to up, down, right and left directions.

3. The remote control for the electronic display apparatus according to claim 2, wherein locations of the four direction keys of the inner ring direction key respectively correspond to locations of the four direction keys of the outer ring direction key.

4. The remote control for the electronic display apparatus according to claim 3, wherein the four direction keys of the inner ring direction key and the four direction keys of the outer ring direction key respectively comprises a common annular press portion, contacts corresponding to up, down, right and left directions are disposed below the common annular press portion.

5. The remote control for the electronic display apparatus according to claim 3, wherein the four direction keys of the inner ring direction key and the four direction keys of the outer ring direction key are separate keys, and contacts are respectively disposed below the direction keys.

6. The remote control for the electronic display apparatus according to claim 1, wherein the preset functions of the keys of the key group are stored in the control module.

7. The remote control for the electronic display apparatus according to claim 6, wherein as for the inner ring direction key, the preset function in the control module is to move a cursor displayed on the display device of the electronic display apparatus one item in a corresponding direction from the present location, and as for the outer ring direction key of the key group, the preset function in the control module is to move the cursor displayed on the display device of the electronic display apparatus more than two items in a corresponding direction from the present location.

8. The remote control for the electronic display apparatus according to claim 1, wherein the signal emitting module is a wireless emitting module comprising an infrared emitting module, or a radio-frequency emitting module, or etc.

9. A remote control for an electronic display apparatus comprising:
an operation panel disposed on a surface of the remote control, and a circuit board located inside the remote control, the circuit board comprising a control module and being connected with the control module, and being capable of emitting signals generated by the remote control to a signal emitting module of a display device of the electronic display apparatus, wherein the operation panel comprises a key group, the key group comprises a first key and a second key, the control module is connected to the key group for recognizing different press operations, if the press operation is on the first key, a signal for making the display device of the electronic display apparatus to perform a preset function one time is emitted through the signal emitting module; if the press operation is on the second key, a signal for making the display device of the electronic display apparatus to perform the preset function more than two times is emitted through the signal emitting module.

10. The remote control for the electronic display apparatus according to claim 9, wherein the preset functions of the keys of the key group are stored in the control module.

11. The remote control for the electronic display apparatus according to claim 9, wherein the preset functions may be volume adjusting, channel switching, play progress changing, cursor moving, page turning, or etc.

12. The remote control for the electronic display apparatus according to claim 9, wherein the signal emitting module is a wireless emitting module comprising an infrared emitting module, or a radio-frequency emitting module, or etc.

13. An electronic display apparatus comprising:
a display device and a remote control, the remote control comprising an operation panel disposed on a surface of the remote control, and a circuit board located inside the remote control, the circuit board comprising a control module and being connected with the control module, and being capable of emitting signals generated by the remote control to a signal emitting module of the display device, wherein the operation panel comprises a key group, the key group comprises a first key and a second key, the control module is connected to the key group for recognizing different press operations, if the press operation is on the first key, a signal for performing a preset function one time is emitted to the display device through the signal emitting module, and the display device performs the preset function one time; if the press operation is on the second key, a signal for performing the preset function more than two times is emitted to the display device through the signal emitting module, and the display device performs the preset function more than two times.

14. The electronic display apparatus according to claim 13, wherein the display device comprises a signal receiving module.

15. The electronic display apparatus according to claim 13, wherein the preset functions of the keys of the key group of the remote control are stored in the control module, and the preset function may be volume adjusting, channel switching, play progress changing, cursor moving, page turning, or etc.
